(19) United States
(12) Patent Application Publication
(10) Pub. No.: US 2014/0311589 A1
(43) Pub. Date: Oct. 23, 2014

(54) MULTI-PORT CONNECTOR FOR FLUID ASSEMBLIES

(71) Applicant: Eley Corporation, Lincoln, NE (US)

(72) Inventors: Craig D. Eley, Lincoln, NE (US); Darin L. Schollmeyer, Creighton, NE (US)

(73) Assignee: Eley Corporation, Lincoln, NE (US)

(21) Appl. No.: 14/252,506

(22) Filed: Apr. 14, 2014

Related U.S. Application Data
(60) Provisional application No. 61/812,527, filed on Apr. 16, 2013.

(51) Int. Cl. F16K 11/10; F16L 41/02; F16K 5/06

(52) U.S. Cl. CPC F16K 11/10; F16K 5/0626; F16L 41/021
USPC 137/315.2; 137/798; 137/887; 285/130.1

(57) ABSTRACT

A multi-port connector is provided with a body having an inlet port associated with a primary outlet port and a plurality of auxiliary outlet ports. The auxiliary outlet ports may include valve systems for selective fluid engagement with a fluid source. The primary outlet port of the body is valve-free in some embodiments, allowing the connector to be coupled with additional multi-port connectors to form multi-line fluid manifolds.

### CROSS-REFERENCE TO RELATED APPLICATION(S)

This application claims the benefit of U.S. Provisional Patent Application No. 61/812,527, filed Apr. 16, 2013, which is incorporated herein by reference in its entirety for all purposes.

### BACKGROUND

Fluid distribution systems, such as the ubiquitous hose bib and water faucet, are found on the exteriors of many commercial and residential sites. Frequently, outdoor water faucets are also imperative features found at construction job sites. Oftentimes, a single faucet and single hose connection to that faucet are sufficient for performing a wide variety of watering tasks at any given site. However, in a number of applications, users may require multiple water lines to extend from a single faucet. For example, some residential homes require a single, dedicated water line be provided to temporary or seasonal landscape water distribution needs, such as water features, drip lines, and the like. However, where the homeowner also requires a hose line for basic watering needs around the exterior of the home, the first hose has to be uncoupled from the faucet and a second line, such as a common hose reel, is then coupled to the faucet.

Construction sites having at least one exterior water faucet find many uses for the water source. For example, the mixing of concrete and other materials with water is just as common as the need for irrigation, tool cleaning, and the like. Previous attempts to couple multiple water lines to a single faucet source have included the ubiquitous Y-connector, which includes a water inlet that threadably secures to the faucet and provides two oppositely faced, threaded outputs. However, such prior art designs provide little control, or adaptability, where more than two outlets are required. For example, particular applications may require a continuous flow of water to a first destination; whereas, the flow to a second destination must be intermittently terminated at the source. Common Y-connectors do not provide sufficient control over such needs.

In various applications, users may require more than two water outputs. In such situations, it becomes cumbersome, if not impossible, to couple more than one Y-connector to one another to create a proper manifold for supplying three or more water output lines from a single source. Prior art connector designs simply do not provide the needed geometry or valve control that would provide a simple, inexpensive solution to these long felt industry needs.

### SUMMARY

This Summary is provided to introduce a selection of concepts in a simplified form that are further described below in the Detailed Description. This Summary, and the foregoing Background, is not intended to identify key aspects or essential aspects of the claimed subject matter. Moreover, this Summary is not intended for use as an aid in determining the scope of the claimed subject matter.

A multi-port connector of the present technology includes a body, having an inlet port and a primary outlet port. A first fluid pathway extends between the inlet port and primary outlet port. The multi-port connector further includes a first auxiliary outlet port and second auxiliary outlet port. A second fluid pathway extends between the inlet port and the first auxiliary outlet port. Similarly, a third fluid pathway extends between the inlet port and the second auxiliary outlet port.

One or more valve assemblies may be associated with the multi-port connector, closely adjacent either or both of the first auxiliary outlet port and second auxiliary outlet port. In some embodiments ball valves are rotatably seated within a first valve chamber and second valve chamber, respectively. Pairs of valve seats are positioned at opposite ends of the ball valves to limit passage of fluid around the ball valves. End caps may be removably coupled with the first auxiliary outlet port and second auxiliary outlet port in order to provide access to the first valve chamber and second valve chamber, such that the user may be granted access to the valve assemblies for maintenance or replacement of the valve assembly.

The primary outlet port may be provided with a hose cap and hose washer to prohibit fluid passage through the primary outlet port. In other embodiments, the multi-port connector may be operatively coupled with one or more additional multi-port connectors to provide a larger fluid manifold with additional fluid line outputs. In particular, a first multi-port connector is coupled with a fluid source. The primary outlet port of the multi-port connector prime is threadably coupled with the inlet port of a second multi-port connector so that the inlet port of the first multi-port connector is in open fluid communication with the inlet port of the second multi-port connector, along the first fluid pathway. In this manner, a fluid manifold with at least four output lines is provided for removable coupling with a fluid source, such as an exterior faucet.

These and other aspects of the present system and method will be apparent after consideration of the Detailed Description and Figures herein. It is to be understood, however, that the scope of the invention shall be determined by the claims as issued and not by whether given subject matter addresses any or all issues noted in the Background or includes any features or aspects recited in this Summary.

### DRAWINGS

Non-limiting and non-exhaustive embodiments of the present invention, including the preferred embodiment, are described with reference to the following figures, wherein like reference numerals refer to like parts throughout the various views unless otherwise specified.

FIG. 1 depicts a perspective view of one embodiment of the multi-port connector of the present technology.

FIG. 2 depicts a front elevation view of the multi-port connector of FIG. 1.

FIG. 3 depicts a top, plan view of the multi-port connector of FIG. 1.

FIG. 4 depicts a side elevation view of the multi-port connector depicted in FIG. 1.

FIG. 5 depicts a cutaway, side elevation view of the multi-port connector of FIG. 1.

FIG. 6 depicts an exploded, perspective view of the multi-port connector depicted in FIG. 1.

FIG. 7 depicts a perspective view of two multi-port connectors of the present technology and demonstrates one manner in which they may be coupled to one another and at least for output fluid lines.

### DETAILED DESCRIPTION

Embodiments are described more fully below with reference to the accompanying figures, which form a part hereof and show, by way of illustration, specific exemplary embodiments. These embodiments are disclosed in sufficient detail to enable those skilled in the art to practice the invention. However, embodiments may be implemented in many different forms and should not be construed as being limited to the embodiments set forth herein. The following detailed description is, therefore, not to be taken in a limiting sense.

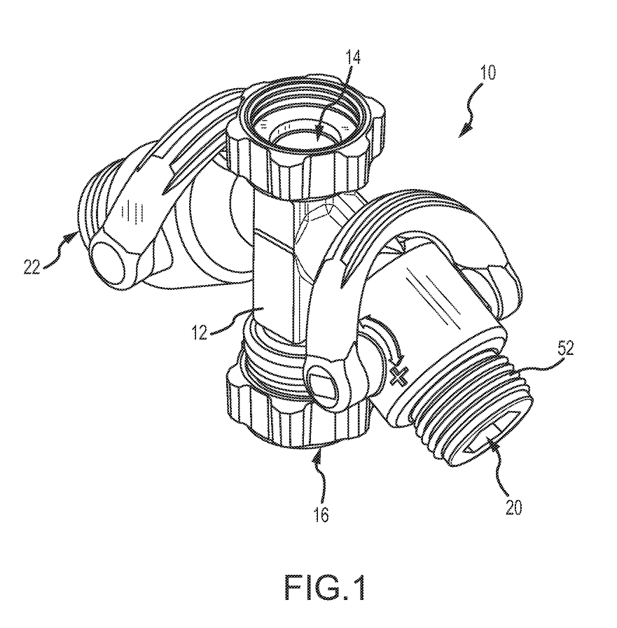

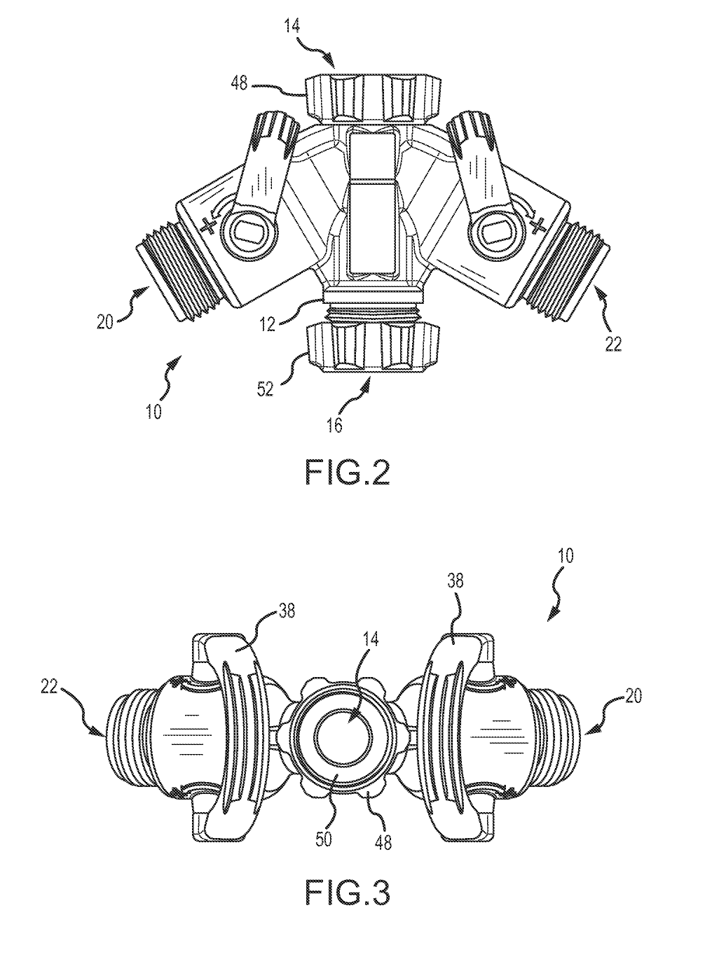

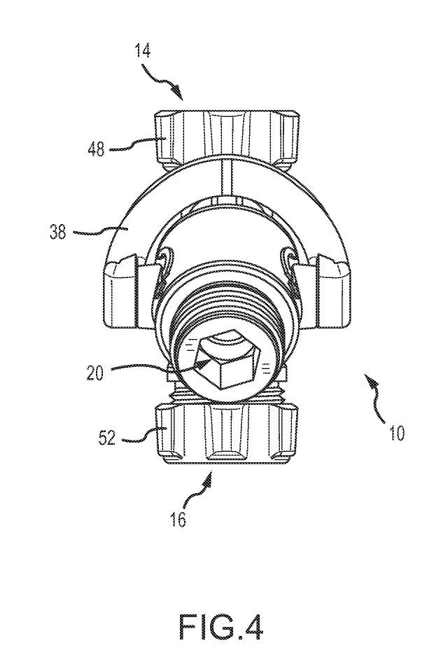

With reference to FIGS. 1-6, a multi-port connector 10 generally includes a body 12, having an inlet port 14 and a primary outlet port 16. In various embodiments, a first fluid pathway 18 extends between the inlet port 14 and primary outlet port 16, such that they are placed in open fluid communication with one another. In some embodiments, the first fluid pathway 18 is provided with a long axis that is coaxial with the inlet port 14 and the primary outlet port 16; disposing the two orifices directly opposite one another. It is contemplated, however, that the alignment of the two orifices may be aligned differently to accommodate various intended uses.

The multi-port connector 10 also includes a first auxiliary outlet port 20 and second auxiliary outlet port 22. A second fluid pathway 24 extends between the inlet port 14 and the first auxiliary outlet port 20, placing the inlet port 14 and the first auxiliary outlet port 20 in fluid communication with one another. Similarly, a third fluid pathway 26 extends between the inlet port 14 and the second auxiliary outlet port 22, placing the inlet port 14 and the second auxiliary outlet port 22 in fluid communication with one another. In at least one embodiment, the first fluid pathway 18, second fluid pathway 24, and third fluid pathway 26, intersect one another at a point downstream from the inlet port 14, inside the body 12. In various embodiments, the first auxiliary outlet port 20 and second auxiliary outlet port 22 are oriented to face at least partially away from the inlet port 14. In this manner, obtuse angles are created between each of the second fluid pathway 24 and third fluid pathway 26 with a long axis that extends into the body 12 from the inlet port 14. Reciprocally, acute angles are defined by each of the second fluid pathway 24 and third fluid pathway 26 with a long axis that extends outwardly from the body 12 from the primary outlet port 16. While this configuration may provide a desirable laminar flow of fluid through the body 12 and the first auxiliary outlet port 20 and second auxiliary outlet port 22, it is contemplated that alternate embodiments of the multi-port connector 10 may dispose the first auxiliary outlet port 20 and second auxiliary outlet port 22 in different directions, such as extending transversely to a long axis extending through the inlet port 14 or acutely with such long axis.

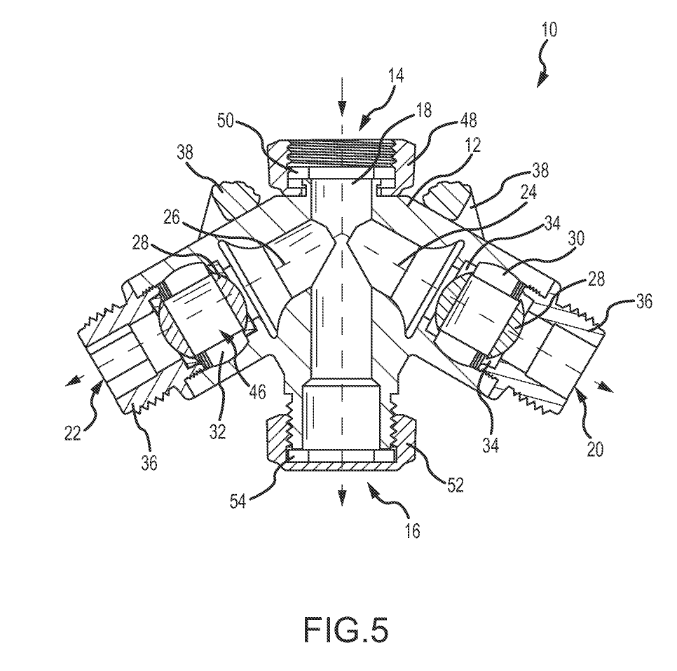

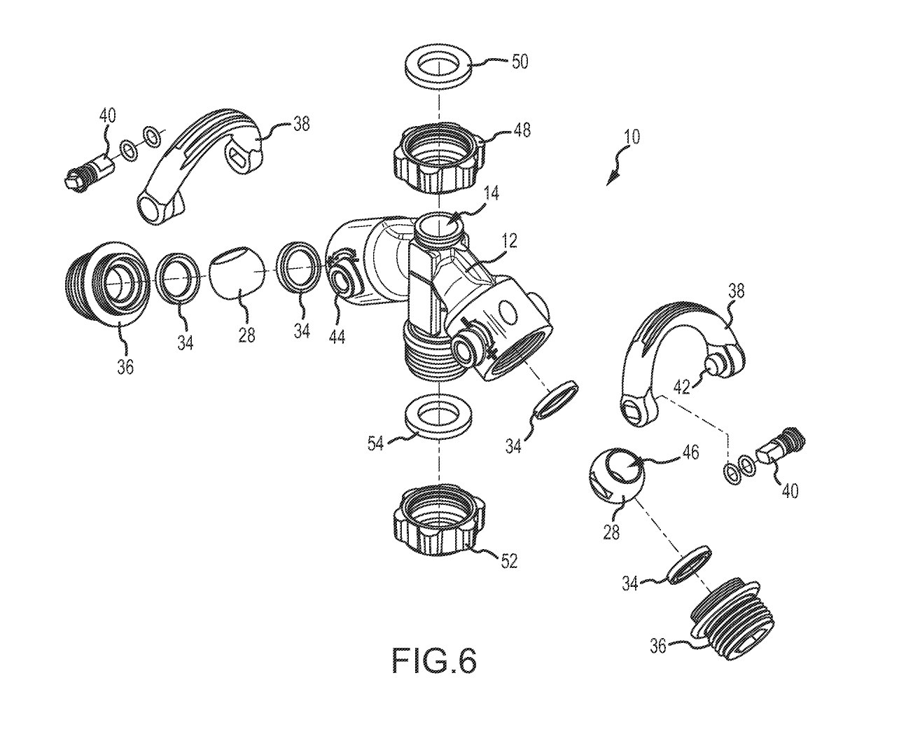

In various embodiments, one or more valve assemblies may be associated with the multi-port connector 10. In some embodiments, manually actuated valves may be positioned within the body 12, closely adjacent either or both of the first auxiliary outlet port 20 and second auxiliary outlet port 22. In the embodiment depicted in FIG. 6, a pair of ball valves 28 are disposed within the body 12, adjacent the first auxiliary outlet port 20 and second auxiliary outlet port 22. With further reference to FIGS. 5 and 6, the ball valves 28 are rotatably seated within a first valve chamber 30 and second valve chamber 32, respectively. Pairs of valve seats 34 are positioned at opposite ends of the ball valve 28 to limit passage of fluid around the ball valves 28. In various embodiments, ball valve end caps 36 may be removably coupled with the first auxiliary outlet port 20 and second auxiliary outlet port 22 in order to provide access to the first valve chamber 30 and second valve chamber 32. Where the ball valve end caps 36 are removably associated with the body 12, through mating threads, or the like, the user may be granted access to the valve assemblies for maintenance or replacement of the valve assembly. Moreover, use of the removable ball valve end caps 36 provides ease of assembly during manufacturing.

In various embodiments, ball valve bales 38 may be rotatably coupled with the exterior of the body 12 and secured with the ball valves 28 using a ball valve spindle 40. The ball valve bales 38 may, in some embodiments, be provided with a pair of mounting pins 42 that extend inwardly from the distal end portions of the U-shaped ball valve bales 38. The mounting pins 42 may be positioned to extend within a pair of oppositely disposed mounting collars 44 that extend outwardly from the body 12, adjacent the first auxiliary outlet port 20 and second auxiliary outlet port 22. The ball valve spindles 40 secure the ball valve bales 38 with their respective ball valves 28, such that rotational movement of the ball valve bales 38 rotate the ball valves 28. In some embodiments, the ball valves 28 have crescent grooves that engage a mating key shape of the ball valve spindles 40. The rotational movement of the ball valve bales 38 place the ball valve apertures 46 into and out of fluid communication with the second fluid pathway 24 and third fluid pathway 26. It is contemplated that other valve mechanisms could be used to place the first auxiliary outlet port 20 and second auxiliary outlet port 22 into and out of open fluid communication with the inlet port 14. The depicted embodiments of the ball valve bales 38, and their orientation with respect to the adjacent structures, don't need to be oriented “front to back” due to the unique wrap around ball valve bales 38. They are ambidextrous in operation. This is an advantage over prior art bale systems, which have the valve control on one side.

In various embodiments, the inlet port 14 of the multi-port connector 10 is provided with a female swivel nut 48 and hose washer 50 that are rotatably secured with a body 12, closely adjacent the inlet port 14. In this embodiment, the multi-port connector 10 may be removably coupled with most common garden hose-style faucets located in various commercial and residential settings. It is contemplated, however, that the multi-port connector 10 may be provided with other quick-disconnect fittings for removable coupling to fluid sources. It is further contemplated that the multi-port connector 10 may be provided such that the inlet port 14 is permanently coupled with a fluid delivery source.

With reference to FIGS. 1-6, the primary outlet port 16 may be provided with a hose cap 52 and hose washer 54. It should be appreciated that use of the hose cap 52 and hose washer 54 will prohibit fluid passage through the primary outlet port 16, providing the only available fluid outlet through the first auxiliary outlet port 20 and second auxiliary outlet port 22. In this manner, selective output of the fluid from the inlet port 14, through the body 12 and out of either or both of the first auxiliary outlet port 20 and second auxiliary outlet port 22 may be affected through manual or automated actuation of the valve assemblies associated with those outlet ports. However, it is also contemplated that additional fluid lines may be coupled with the primary outlet port 16 and provided with a nearly limitless number of fluid line outputs, such as hand sprayers, irrigation assemblies, and the like. In such embodiments, the fluid delivery hardware associated with the end of a fluid output line coupled with the primary outlet port 16 will provide selective fluid output from the multi-port connector 10, obviating the need for a third valve assembly within the system.

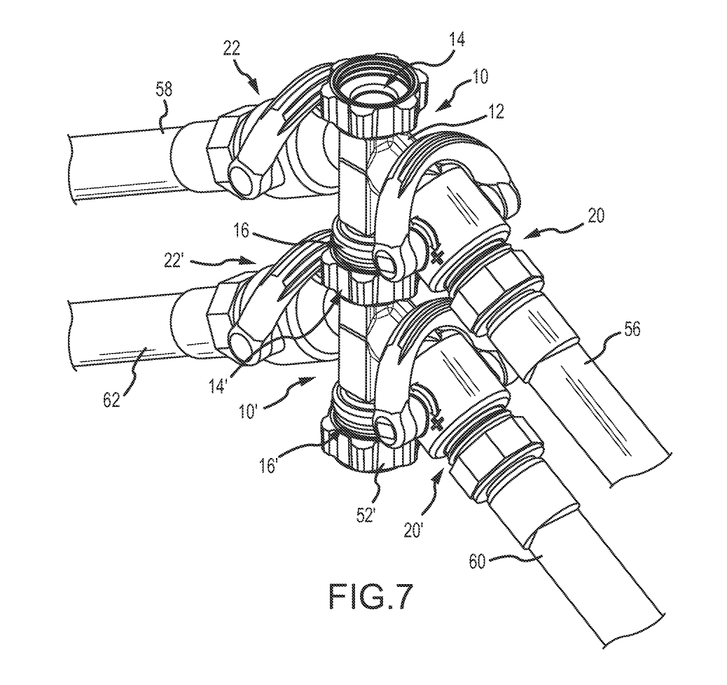

With reference to FIG. 7, the multi-port connector 10 may be operatively coupled with one or more additional multi-port connectors in order to provide a larger fluid manifold with additional fluid line outputs. In the exemplary embodiment depicted in FIG. 7, a first multi-port connector 10 is provided so that its inlet port 14 is associated with a fluid source. A first fluid output line 56 is associated with the first auxiliary outlet port 20 and a second fluid output line 58 is associated with the second auxiliary outlet port 22. The primary outlet port 16 of the multi-port connector 10 prime is threadably coupled with the inlet port 14′ of a second multi-port connector 10′. In this manner, the inlet port 14 of the first multi-port connector 10 is in open fluid communication with the inlet port 14′ of the second multi -port connector 10 double prime, along the first fluid pathway 18. A third fluid output line 60 is associated with the first auxiliary output port 20′ and a fourth fluid output line 62 is associated with the second auxiliary output port 22′. A hose cap 52′ and hose washer may be threadably secured to the primary fluid output port 16′ of the second multi -port connector 10′ to secure fluid output from the system. In this manner, a fluid manifold is provided for removable coupling with a fluid source, such as an exterior faucet. The assembled manifold includes four output lines that are selectively controllable for fluid engagement with the fluid source. It is contemplated that nearly any number of multi-port connectors may be connected with one another in this manner, depending on the total number of output lines desired. The resulting fluid line manifold may be quickly and easily formed to provide the desired number of output lines from a single fluid source.

Although the technology been described in language that is specific to certain structures, materials, and methodological steps, it is to be understood that the invention defined in the appended claims is not necessarily limited to the specific structures, materials, and/or steps described. Rather, the specific aspects and steps are described as forms of implementing the claimed invention. Since many embodiments of the invention can be practiced without departing from the spirit and scope of the invention, the invention resides in the claims hereinafter appended. Unless otherwise indicated, all numbers or expressions, such as those expressing dimensions, physical characteristics, etc. used in the specification (other than the claims) are understood as modified in all instances by the term “approximately.” At the very least, and not as an attempt to limit the application of the doctrine of equivalents to the claims, each numerical parameter recited in the specification or claims which is modified by the term “approximately” should at least be construed in light of the number of recited significant digits and by applying ordinary rounding techniques. Moreover, all ranges disclosed herein are to be understood to encompass and provide support for claims that recite any and all subranges or any and all individual values subsumed therein. For example, a stated range of 1 to 10 should be considered to include and provide support for claims that recite any and all subranges or individual values that are between and/or inclusive of the minimum value of 1 and the maximum value of 10; that is, all subranges beginning with a minimum value of 1 or more and ending with a maximum value of 10 or less (e.g., 5.5 to 10, 2.34 to 3.56, and so forth) or any values from 1 to 10 (e.g., 3, 5.8, 9.9994, and so forth).

What is claimed is:

1. A connector for a fluid handling system, the connector comprising:
a body having an inner chamber, inlet port, and a primary outlet port; the inlet port and primary outlet port being in open fluid communication with one another such that a first fluid pathway extends between the inlet port and the primary outlet port through the inner chamber; and
at least one auxiliary outlet port, in open fluid communication with the inner chamber of the body and the inlet port such that a second fluid pathway extends between the inlet port and the at least one auxiliary outlet port;
at least a portion of the second fluid pathway extending away from the first fluid pathway at an angle such that the at least one auxiliary outlet port and the inlet port are not coaxially aligned with one another.

2. The connector of claim 1 further comprising:
a first auxiliary outlet port, in open fluid communication with the inner chamber of the body and the inlet port such that the second fluid pathway extends between the inlet port and the first auxiliary outlet port; and
a second auxiliary outlet port, in open fluid communication with the inner chamber of the body and the inlet port such that a third fluid pathway extends between the inlet port and the first auxiliary outlet port;
at least a portion of the third fluid pathway extending away from the first fluid pathway at an angle such that the second outlet port and the inlet port are not coaxially aligned with one another.

3. The connector of claim 2 wherein the second fluid pathway and the third fluid pathway extend away from one another in divergent directions.

4. The connector of claim 3 wherein the first fluid pathway, second fluid pathway, and third fluid pathway, intersect one another at a point downstream from the inlet port, within the inner chamber of the body.

5. The connector of claim 3 wherein the first auxiliary outlet port and second auxiliary outlet port are oriented to face at least partially away from the inlet port such that obtuse angles are created between each of the second fluid pathway and third fluid pathway with a long axis that extends into the body from the inlet port.

6. The connector of claim 5 wherein acute angles are defined by each of the second fluid pathway and third fluid pathway with a long axis that extends outwardly from the body from the primary outlet port.

7. The connector of claim 1 wherein the first fluid pathway extends along a long axis that is coaxially aligned with the inlet port and the primary outlet, such that the inlet port and the primary outlet are positioned opposite one another.

8. The connector of claim 1 further comprising:
a valve assembly positioned within the inner chamber of the body, closely adjacent the first auxiliary outlet port; the valve assembly being selectively movable between an open position permitting fluid travel along the second fluid pathway and out the first auxiliary port, and a closed position that restricts fluid travel along the second fluid pathway.

9. The connector of claim 1 further comprising:
a first valve assembly positioned within the inner chamber of the body, closely adjacent the first auxiliary outlet port; the first valve assembly being selectively movable between an open position permitting fluid travel along the second fluid pathway and out the first auxiliary port, and a closed position that restricts fluid travel along the second fluid pathway; and
a second valve assembly positioned within the inner chamber of the body, closely adjacent the first auxiliary outlet port; the second assembly being selectively movable between an open position permitting fluid travel along the second fluid pathway and out the first auxiliary port, and a closed position that restricts fluid travel along the second fluid pathway.

10. The connector of claim 9 wherein:
the first valve assembly includes a first ball valve disposed within the inner chamber of the body, adjacent the first auxiliary outlet port; the first ball valve being rotatably seated within a first valve chamber between a pair of valve seats that limits passage of fluid around the first ball valve; and
the second valve assembly includes a second ball valve disposed within the inner chamber of the body, adjacent the second auxiliary outlet port; the second ball valve being rotatably seated within a second valve chamber between a pair of valve seats that limits passage of fluid around the second ball valve.

11. The connector of claim 10 further comprising:
a first ball valve end cap that is shaped to be removably coupled with the first auxiliary outlet port in a manner that provides selective access to the first valve chamber; and
a second ball valve end cap that is shaped to be removably coupled with the second auxiliary outlet port in a manner that provides selective access to the first valve chamber.

12. The connector of claim 11 wherein the first ball valve end cap and second ball valve end cap are removably, threadably coupled with the body.

13. The connector of claim 10 further comprising:
a first ball valve bale that is rotatably coupled with the body and coupled with the first ball valve with a first ball valve spindle such that rotational movement of the first ball valve bale rotates the first ball valve; and
a second ball valve bale that is rotatably coupled with the body and coupled with the second ball valve with a second ball valve spindle such that rotational movement of the second ball valve bale rotates the second ball valve.

14. The connector of claim 1 further comprising:
a female swivel nut and hose washer that are rotatably coupled with the body, closely adjacent the inlet por.

15. The connector of claim 1 further comprising:
a hose cap and hose washer that are removably coupled with the primary outlet port in a manner that selectively prohibits fluid passage through the primary outlet port.

16. A connector system for a fluid handling system, the connector system comprising:
a first connector comprising:
a body having an inner chamber, inlet port, and a primary outlet port; the inlet port and primary outlet port being in open fluid communication with one another such that a first fluid pathway extends between the inlet port and the primary outlet port through the inner chamber; and
at least one auxiliary outlet port, in open fluid communication with the inner chamber of the body and the inlet port such that a second fluid pathway extends between the inlet port and the at least one auxiliary outlet port;
at least a portion of the second fluid pathway extending away from the first fluid pathway at an angle such that the at least one auxiliary outlet port and the inlet port are not coaxially aligned with one another;
a second connector comprising:
a body having an inner chamber, inlet port, and a primary outlet port; the inlet port and primary outlet port being in open fluid communication with one another such that a first fluid pathway extends between the inlet port and the primary outlet port through the inner chamber; and
at least one auxiliary outlet port, in open fluid communication with the inner chamber of the body and the inlet port such that a second fluid pathway extends between the inlet port and the at least one auxiliary outlet port;
at least a portion of the second fluid pathway extending away from the first fluid pathway at an angle such that the at least one auxiliary outlet port and the inlet port are not coaxially aligned with one another;
the inlet port of the second connector being removably coupled with the outlet port of the first connector such that the first fluid pathway of the first connector and the first fluid pathway of the second connector are coaxial with one another.

17. The connector system of claim 16 wherein:
the first connector comprises:
a first auxiliary outlet port, in open fluid communication with the inner chamber of the body and the inlet port such that the second fluid pathway extends between the inlet port and the first auxiliary outlet port; and
a second auxiliary outlet port, in open fluid communication with the inner chamber of the body and the inlet port such that the third fluid pathway extends between the inlet port and the first auxiliary outlet port;
at least a portion of the third fluid pathway extending away from the first fluid pathway at an angle such that the second outlet port and the inlet port are not coaxially aligned with one another.

18. The connector system of claim 17 wherein:
the second connector comprises:
a first auxiliary outlet port, in open fluid communication with the inner chamber of the body and the inlet port such that the second fluid pathway extends between the inlet port and the first auxiliary outlet port; and
a second auxiliary outlet port, in open fluid communication with the inner chamber of the body and the inlet port such that the third fluid pathway extends between the inlet port and the first auxiliary outlet port;
at least a portion of the third fluid pathway extending away from the first fluid pathway at an angle such that the second outlet port and the inlet port are not coaxially aligned with one another.

19. The connector of claim 18 wherein:
the first connector comprises:
a first valve assembly positioned within the inner chamber of the body, closely adjacent the first auxiliary outlet port; the first valve assembly being selectively movable between an open position permitting fluid travel along the second fluid pathway and out the first auxiliary port, and a closed position that restricts fluid travel along the second fluid pathway; and
a second valve assembly positioned within the inner chamber of the body, closely adjacent the first auxiliary outlet port; the second assembly being selectively movable between an open position permitting fluid travel along the second fluid pathway and out the first auxiliary port, and a closed position that restricts fluid travel along the second fluid pathway.

20. The connector of claim 19 wherein:
the second connector comprises:
a first valve assembly positioned within the inner chamber of the body, closely adjacent the first auxiliary outlet port; the first valve assembly being selectively movable between an open position permitting fluid travel along the second fluid pathway and out the first auxiliary port, and a closed position that restricts fluid travel along the second fluid pathway; and
a second valve assembly positioned within the inner chamber of the body, closely adjacent the first auxiliary outlet port; the second assembly being selectively movable between an open position permitting fluid travel along the second fluid pathway and out the first auxiliary port, and a closed position that restricts fluid travel along the second fluid pathway.

21. A connector for a fluid handling system, the connector comprising:
a body having an inner chamber, inlet port, and a primary outlet port; the inlet port and primary outlet port being in open fluid communication with one another such that a first fluid pathway extends between the inlet port and the primary outlet port through the inner chamber;
the first fluid pathway extending along a long axis that is coaxially aligned with the inlet port and the primary outlet, such that the inlet port and the primary outlet are positioned opposite one another; and
a first auxiliary outlet port, in open fluid communication with the inner chamber of the body and the inlet port such that a second fluid pathway extends between the inlet port and the first auxiliary outlet port;
a second auxiliary outlet port, in open fluid communication with the inner chamber of the body and the inlet port such that a third fluid pathway extends between the inlet port and the first auxiliary outlet port;
a first valve assembly positioned within the inner chamber of the body, closely adjacent the first auxiliary outlet port; the first valve assembly being selectively movable between an open position permitting fluid travel along the second fluid pathway and out the first auxiliary port, and a closed position that restricts fluid travel along the second fluid pathway; and
a second valve assembly positioned within the inner chamber of the body, closely adjacent the first auxiliary outlet port; the second assembly being selectively movable between an open position permitting fluid travel along the second fluid pathway and out the first auxiliary port, and a closed position that restricts fluid travel along the second fluid pathway.
the first fluid pathway, second fluid pathway, and third fluid pathway, intersect one another at a point downstream from the inlet port, within the inner chamber of the body.
the first auxiliary outlet port and second auxiliary outlet port are oriented to face at least partially away from the inlet port such that obtuse angles are created between each of the second fluid pathway and third fluid pathway with a long axis that extends into the body from the inlet port.
